(19) United States
(12) Patent Application Publication
(10) Pub. No.: US 2011/0208674 A1
(43) Pub. Date: Aug. 25, 2011

(54) Analyzing No-Show Persons to Fine Tune Event Ticket Overbooking

(76) Inventors: Andrew Jesse Mills, Silver Spring, MD (US); Joseph Finelli, Boston, MA (US)

(21) Appl. No.: 13/031,611

(22) Filed: Feb. 21, 2011

Related U.S. Application Data
(60) Provisional application No. 61/306,556, filed on Feb. 22, 2010.

(51) Int. Cl. G06Q 90/00

(52) U.S. Cl. 705/500

(57) ABSTRACT

The practice of overbooking, where a service provider promises to service more customers than she will be able to in expectation that some customers will cancel their request, has been widely implemented in industries such as hotels and airlines. Overbooking has not widely been used for event tickets. This is likely due to the availability of the secondary market, which allows people with tickets who know beforehand that they cannot attend the event to sell their ticket to someone else. Additionally, the danger of having more people arrive with tickets than there are seats in a venue is large because fans are often emotional. The present invention overcomes these limitations by using previous attendance records to accurately predict future attendance. This allows an event organizer to overbook with confidence that it will be very unlikely too many people will show up with tickets compared to the number of seats available.

### CROSS-REFERENCE TO RELATED APPLICATIONS

This patent application claims the benefit of the filing date from Provisional Patent No. 61/306,556, entitled “Analyzing Attendance and No-Show Data to Fine Tune Event Ticket Overbooking.”

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present invention relates to a method of intelligently overbooking tickets for an upcoming event, based on an analysis of no-show persons of related prior events.

2. Prior Art

The practice of overbooking, where a service provider promises to service more customers than she will be able to in expectation that some customers will cancel their request before service date, has been widely implemented in industries such as hotels and airlines. On the other hand, overbooking has not been used for event tickets hardly at all. In fact, many ticketing systems claim as a core feature that they protect against overbooking, as if overbooking was always a bad thing. Robert Lewis Phillips says in the standard textbook “Pricing and Revenue Optimization,” “most industries that sell nonrefundable bookings (or tickets) do not overbook. Theater tickets and tickets to sporting events are examples. In this case, the risks to the customer of purchasing a ticket is [sic] mitigated by the fact that bookings in these industries are transferable to others—unlike airline tickets.”

While it could be true that the percentage of additional revenue that can be captured by implementing overbooking for event tickets is smaller than the corresponding gain for airline tickets (the authors neither agree nor disagree with this commonly held presumption), the profit margin of, for example, sports teams is reportedly very small. Many sports teams reportedly make no profit and operate at a loss. Further, typical stadiums hold thousands of seats. This means, for example, a typical pro-sports event may have one hundred times more inventory than a typical airplane flight. Even supposing the number of no-shows as a percentage of total inventory is low, the number of no shows is still likely large. In fact, one of the authors has studied in depth the attendance of events held by a pro-sports team. This pro-sports team has a robust and easy to use secondary market so that ticket holders who know in advance they cannot attend an event can sell their ticket to someone who can. Nevertheless, significant numbers of no-shows still happen for every single event.

In real life, heretofore, almost all instances of overbooking event tickets have occurred when the tickets were priced as free (at least by the original issuing party). This is because fans can be very passionate, and so event producers are loathe to risk having more people show up at the event with tickets than there are seats to hold them. For example, the 2008 “Sex and the City” movie premier in New York City was overbooked. Eight thousand people with tickets showed up to see the movie in a six thousand seat theater. This was a public relations disaster. For an account of what transpired, see “‘Sex and the City’ premier turns ugly” from the New York Daily News on May 28, 2008, written by Kerry Burke, Leah Chernikoff, and Bill Hutchinson. People were furious, even though the tickets were free. The organizers of the event made no money from the attendees, but the people with tickets felt like they had the right to attend. The people who had tickets but did not get to see the show felt like they had been taken advantage of. Imagine how much worse it would have been if the tickets cost money!

U.S. Pat. No. 7,110,960 by Phillips et al. (“Event Revenue Management System”) demonstrates ways of bringing revenue management principles into event ticket industry, but is silent on the matter of overbooking.

U.S. Pat. No. 4,775,936 by Jung (“Overbooking System”) demonstrates ways of determining overbooking levels, but these ways are specific to the transportation industry. This patent does not anticipate or foresee the usage of overbooking in the event ticket industry at all.

U.S. Pat. No. 6,895,381 by Selby (“Method and System for Management of a Wait List for Reserved Purchases”) demonstrates ways of calculating the likelihood a person will utilize a service if they are upgraded from being on a wait list to having a reservation. The present invention is not related to wait lists at all.

“Enhancing Revenue in College Sport Events by Practicing Yield Management and E-commerce” by Ho and Jiang mashes up sports events and yield management (including mentioning overbooking briefly), but crucially it does not provide or foresee a method of fine tuning overbooking based on properties of the event, properties of the ticket holders, and/or properties of the reservations (such as which section the seat is in). This is imperative to keep the probability that more people show up with tickets than there are seats in the building small.

All prior art and practice: dismisses the opportunity of overbooking in the event ticket industry as insignificant, prices overbooked tickets for free, or (in the case of Ho and Jiang) vaguely theorizes on overbooking and event tickets but does not envision a specific way to accomplish this effectively.

### OBJECTS AND ADVANTAGES

Accordingly, the advantage of our invention is that it determines the number of no-shows to an event with high accuracy. This means that overbooking an event can be accomplished with only a small probability of having more people show up with tickets than there is space at the door. Since public outcry is unlikely to occur, event organizers can charge money for all tickets and increase their revenue.

### SUMMARY

The present invention is a method of analyzing prior event attendance data to project future attendance rates. The process begins with the collection of historical data expressing the number of attendees and no-shows to past events over a significant period of time, often at least two seasons for a typical pro sports franchise. Next, a wide spectrum of data describing the historical games in question is collected. These “game characteristics” range from simple (such as the day-of-week or month-of-year) to moderate (such as the strength/attractiveness of the opponent or the current win/loss record of the home team) to complex (such as the recent frequency of home games, injuries to star players, or other nearby entertainment options available to the public on a given night). This list is not exhaustive to all the different possibilities.

The next step in the process is to use a multivariate regression (or other type of mathematical correlation) to measure, in statistical terms, the effect of any of the “game characteristics” on the eventual attendance rate of the historical games in question. During this process, it becomes evident which characteristics have (or do not have) a quantifiable effect on the number of no-shows. For example, imagine a team whose no-show rate appears to the naked eye to be higher for games held during the middle of the week compared to games held on Friday night, Saturday, or Sunday. While one might assume that this growth in no-show rate is in fact driven by the day-of-week (and the implied difficulty of attending an entertainment event the night before a work obligation), a statistical regression might reveal that, in fact, the high no-show rate during the middle of the week is driven more by a recent run of low-caliber opponents. This type of finding is central to the ability to forecast attendance rates for future games.

The next step in the process is a collection of “game characteristics” for future games. To be fair, while some characteristics of future games are not knowable until relatively close to the game's start time (for example, the availability of a star player attempting to return from injury), most of a game's core characteristics (such as day-of-week, general caliber of opponent, or applicable in-stadium promotion) are known weeks if not months in advance. And those characteristics that are not completely known in advance can be predicted or guessed.

The next step in the process is the application of the previously calculated effects of these “game characteristics” in order to project the attendance rate at future games. This is done using the result of the multivariate regression (or other mathematical correlation) discussed earlier. This process will project a no-show rate for a future game even when that particular combination of characteristics (i.e. day-of-week, strength of opponent, etc) has not been observed before. This is one of the particularly compelling capabilities of this process.

It is noted that all of the preceding can be done on a section by section basis, as some sections may have different no-show patterns than others.

Finally, based on the expected attendance rate, a number of additional tickets are issued. To even further reduce the chance that more people will attempt to attend an event than there is room for, the output of the projection can be multiplied by a factor greater than one. And the number of additional tickets issued, which would logically be equal to the capacity of the venue (or a section of it) minus the number of projected attendees, can be multiplied down by a fraction less than one.

A related method to what was described above finds the probability that one person who has made a reservation will show up to the event. This method is similar to the above, except that it can incorporate characteristics of the person and the specific reservation (such as when that reservation was made and what section the seat is in) into the mathematical regression. This leads to extra power and accuracy. For example, a person who buys a package of twenty games is likely to show up to fewer games than the aggregate of twenty people who each have bought one game. That is because a person is very unlikely to buy a ticket for one specific game they know they cannot attend. However, a person might buy a twenty game ticket package knowing they could not attend every game in the package.

This method can obviously be generalized to find the expected number of no-shows from a group of individuals (not just one individual), based on properties of that group and the group's reservation(s).

What is claimed is:

1. A method of overbooking tickets to an upcoming event, comprising:
a. collecting the numbers of no-show persons to past events,
b. collecting characteristics of past events,
c. determining a mathematical correlation between the results of parts a and b,
d. collecting or predicting characteristics of an upcoming event,
e. applying said mathematical correlation to said characteristics of said upcoming event to predict the number of no-show persons to said upcoming event who would have been situated in a particular portion of said upcoming event's venue,
f. subtracting the capacity of said particular portion of said upcoming event's venue minus a factor times the answer of part e, and
g. issuing an amount of additional tickets for said upcoming event, located in said specific portion of said upcoming event's venue, equal to a fraction of the answer of part f.

2. The method of 1 wherein said factor is one.

3. The method of 1 wherein said fraction is one.

4. The method of 1 whereby said numbers of no-show persons in part a are a series of numbers of no-show persons for different portions of the stadium.

5. A method of predicting whether a group of persons will attend an upcoming event, comprising:
a. collecting a list of attendees and no-show persons for past events,
b. collecting characteristics of said attendees and no-show persons to said past events,
c. determining a mathematical correlation between the results of parts a and b,
d. collecting characteristics of a group of persons, and
e. applying said mathematical correlation found to said characteristics of said group of persons to estimate the number of persons in said group of persons who will attend said upcoming event.

6. The method of 5 wherein the size of said group of persons in part d is one.

7. The method of 5, further comprising: said mathematical correlation of part c also takes into account characteristics of the reservations said attendees and no-show persons made to said past events in part a and the estimation in part e also takes into account characteristics of the reservation or reservations said group of persons in part d made to said upcoming event.

8. The method of 5, further comprising: said mathematical correlation of part c also takes into account characteristics of said past events and the estimation in part e also takes into account characteristics collected about or predicted of said upcoming event.

9. The method of 7, further comprising: said mathematical correlation of part c also takes into account characteristics of said past events and the estimation in part e also takes into account characteristics collected about or predicted of said upcoming event.

10. The method of 5, further comprising: issuing an amount of additional tickets to said upcoming event equal to a fraction times the subtraction of the capacity of a super-class of tickets that said group of persons bought minus a factor times the result of part 5e.

11. The method of 5, further comprising: issuing an amount of additional tickets to said upcoming event equal to a fraction times the subtraction of the capacity of a super-class of tickets that said group of persons bought minus a factor times the result of part 5e.

12. The method of 6, further comprising: issuing an amount of additional tickets to said upcoming event equal to a fraction times the subtraction of the capacity of a super-class of tickets that said group of persons bought minus a factor times the result of part 5e.

13. The method of 7, further comprising: issuing an amount of additional tickets to said upcoming event equal to a fraction times the subtraction of the capacity of a super-class of tickets that said group of persons bought minus a factor times the result of part 5e.

14. The method of 8, further comprising: issuing an amount of additional tickets to said upcoming event equal to a fraction times the subtraction of the capacity of a super-class of tickets that said group of persons bought minus a factor times the result of part 5e.

15. The method of 9, further comprising: issuing an amount of additional tickets to said upcoming event equal to a fraction times the subtraction of the capacity of a super-class of tickets that said group of persons bought minus a factor times the result of part 5e.

16. A method of predicting whether a group of persons will attend an upcoming event, comprising:
a. collecting a list of attendees and no-show persons for past events,
b. collecting characteristics of the reservations said attendees and no-show persons made to said past events,
c. determining a mathematical correlation between the results of parts a and b,
d. collecting characteristics of the reservation or reservations a group of persons have made to an upcoming event, and
e. applying said mathematical correlation found to said characteristics of said reservation or reservations of said group of persons to estimate the number of persons in said group of persons who will attend said upcoming event.

17. The method of 16 wherein the size of said group of persons in part d is one.

18. The method of 16, further comprising: said mathematical correlation of part c also takes into account characteristics of said past events and the estimation in part e also takes into account characteristics collected about or predicted of said upcoming event.

19. The method of 16, further comprising: issuing an amount of additional tickets to said upcoming event equal to a fraction times the subtraction of the capacity of a super-class of tickets that said group of persons bought minus a factor times the result of part 16e.

20. The method of 17, further comprising: issuing an amount of additional tickets to said upcoming event equal to a fraction times the subtraction of the capacity of a super-class of tickets that said group of persons bought minus a factor times the result of part 16e.

21. The method of 18, further comprising: issuing an amount of additional tickets to said upcoming event equal to a fraction times the subtraction of the capacity of a super-class of tickets that said group of persons bought minus a factor times the result of part 16e.
